(19) United States
(12) Patent Application Publication
(10) Pub. No.: US 2006/0215140 A1
(43) Pub. Date: Sep. 28, 2006

(54) Method of measuring the performance of an illumination system

(76) Inventors: Peter Dirksen, Leuven (BE); Casparus Antonius Henricus Juffermans, Leuven (BE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/540,067

(22) PCT Filed: Dec. 18, 2003
(86) PCT No.: PCT/IB03/06142

§ 371 Date: Jun. 22, 2005

(30) Foreign Application Priority Data
Dec. 30, 2002 (EP) 02080544.6

(51) Int. Cl. G03B 27/72

(52) U.S. Cl. 355/69; 355/67; 355/77

(57) ABSTRACT

The performance of an illumination system in, for example, a lithographic projection apparatus can be measured accurately and reliably by means of a test object (55) comprising at least one Fresnel zone lens (30) and an associated reference mark, preferably a ring (40). By superposed imaging of these and detecting and evaluating the composed image (56), telecentricity errors and aberrations of the illumination can be measured.

The invention relates to a method of measuring the performance of an illumination system, which comprises a radiation source and is used in an imaging apparatus, which method comprises the steps of:

providing a test object comprising at least one Fresnel zone lens;

arranging the test object in the object plane of the imaging apparatus;

imaging a test object area comprising a Fresnel zone lens in an imaging plane by means of an illumination beam supplied by the illumination system and by means of the imaging system of the apparatus, whereby a local effective source is imaged in the image plane;

evaluating the image of the local effective source by means of a detection device and associated processing means to determine the performance of the illumination system.

The invention also relates to a test object for use with the method, to a method of manufacturing a device including the measuring method and to a device manufactured by means of the method of manufacturing.

A local effective source is understood to mean the distribution of waves, and thus radiation, which the illumination system forms in the plane of the test object.

U.S. Pat. No. 6,048,651 relates to such a method for testing of the illumination system of precision image projection apparatus used in integrated circuit lithography. The optical imaging system may comprise refractive elements, reflective elements or a combination of these elements. An optical imaging system in the form of a projection system, having a large number of lenses or mirrors is used in photolithographic projection apparatuses, which are known as wafer steppers or wafer step-and-scanners. The projection system for such an apparatus, which may be a lens system or a mirror system or a system comprising lenses and mirrors, will be referred to hereinafter as projection lens. Lithographic projection apparatuses are used, inter alia, for manufacturing integrated circuits, or ICs. In a photolithographic projection apparatus a production mask pattern, present in a production mask is imaged a large number of times, each time in a different area, also called IC area, shot area or die, in a resist layer on top of a substrate or wafer. Imaging is performed by means of a projection (imaging) system and a projection beam having a wavelength in the UV range, for example 365 nm, or a wavelength in the deep UV range, for example 248 nm, 193 nm or 157 nm.

The aim in IC manufacturing is to supply ICs which have an ever-increasing signal processing speed and comprise an ever-increasing number of electronic components. To realise this, it is desirable to increase the surface area of an IC and to decrease the size of the components. For the projection apparatus this means that both the image field and the resolution of its projection lens must be increased, so that increasingly smaller details, or line widths, can be imaged in a well-defined way in an increasingly larger image field. This means that a projection lens, which satisfies very stringent quality requirements and shows negligible aberrations, like coma spherical aberration, coma and astigmatism, is needed. An effective method of and system for measuring the performance of a projection lens was described earlier.

For the envisaged smaller details to be imaged also the quality of the illumination system and its alignment with respect to the projection system becomes ever more important. The illumination system used in lithographic projection apparatuses comprises a radiation source, a lens- or mirror-condensor system for concentrating the radiation supplied by the source in an illumination beam, a so-called integrator for rendering the radiation distribution across the beam cross section uniform. Current lithographic projection apparatuses use a so-called Kohler illumination, i.e. the radiation source is imaged in the pupil plane of the projection lens. The illumination system creates a distribution of plane waves of source radiation in the plane of the mask pattern, which distribution is called: the local effective source. Aberrations in the illumination system change the said distribution and thus cause a variation of the shape of the effective source across the plane of the mask pattern and thus across the field of the projection lens.

For testing an illumination system, U.S. Pat. No. 6,048,651 uses a photomask that, instead of with an IC pattern, is provided with a Fresnel lens structure, which is called: Fresnel zone target (FZT) in the patent. This photomask is illuminated by the illumination system to be tested and imaged by a projection lens in an image plane and the radiation distribution in the image plane, which distribution is called pupil diagram, is evaluated to determine the illumination system adjustment. For the evaluation, in the image plane a resist-coated wafer, a photosensitive film or an electronic image sensor may be arranged.

It is an object of the invention to provide a method as defined in the opening paragraph of this description, which has more capabilities than the method of U.S. Pat. No. 6,048,651, i.e. allows measuring more illumination system parameters. This method is characterized in that the step of providing a test object comprises providing a test object having for each Fresnel zone lens a reference mark and in that the step of imaging comprises imaging the Fresnel zone lens area and the corresponding reference mark area within the field of view of the detection device.

Imaging in the field of view of the detection system is understood to mean that the Fresnel zone lens and the reference mark are imaged close to each other so that they can be viewed by the detection device as one composed image that can be evaluated as one image.

Imaging a reference mark belonging to a Fresnel zone lens, which mark has a well defined position with respect to the Fresnel zone lens, at a well-defined position in the image plane allows determining the position of the image of the Fresnel in an easy way. The centre of the reference mark image can be used as the origin of a two-dimensional co-ordinate system and the shape and dimension of the effective source image can be determined by means of the origin and the axes of this co-ordinate system.

The Fresnel zone lens and the reference mark may be imaged next to each other. A preferred embodiment of the method is, however, characterized in that the Fresnel zone lens area and the corresponding reference mark area are imaged as being superposed.

This allows more accurate and faster measuring because the position of the image of the local effective source needs no to be “translated” to the position of the reference mark. Superposed imaging of the local effective source and the reference mark allows measuring telecentricity errors. A telecentricity error is understood to mean a deviation between the centre of the radiation source image formed in the pupil of the projection lens and the centre of this pupil. A telecentricity error may cause image distortions, which vary with the variation of focus and may affect the accuracy with which a mask pattern can be aligned with respect to a substrate or wafer.

The reference mark may be formed by small lines arranged at angles of 90° with respect to each other and which may be distinct lines or lines that together form a square. The reference mark may have any form, provided that it has a clearly discernible centre.

Preferably the method is further characterized in that the reference mark is an annular mark.

This allows comparing the shape of the image of the local effective source, which should be circular, with the circular contour lines of the image of the annular reference mark (hereinafter: reference ring). In this way different types of aberrations of the illuminating system can be determined.

Preferably, the method is characterized in that the test object is imaged out of focus over a distance equal to the focal length of the Fresnel zone lens and in that the reference mask is imaged at best focus condition.

In this way a sharp image of the local effective source is formed in the image plane of the projection system.

A preferred embodiment of the method is characterized in that for imaging the Fresnel zone lens an illumination dose is used that is substantially higher than the illumination dose used for imaging the reference mark.

In this way it is achieved that also the image of the illumination source is sufficiently bright to allow reliable detection of this image.

As for imaging of the local effective source the imaging system is used, possibly transmission errors of the imaging system may affect the result of the illumination system measurement. To eliminate, or reduce sufficiently, the influence of such transmission errors an embodiment of the method, which uses a test object having a number of Fresnel zone lenses and associated reference masks, is characterized in that measures are taken to direct radiation from each Fresnel zone lense at a different angle through the pupil of the imaging system.

A number of the sub-beams from several Fresnel zone lenses all pass through possible transmission error areas of the imaging system, such that the effect of these errors is spread over the composed image and thus is eliminated.

Alternatively the method is characterized in that before the illumination system is measured, the imaging system is illuminated by diffuse radiation and the radiation distribution in its image plane is measured to detect transmission errors of the illumination system and in that the results of the illumination system measurement are corrected for the said transmission errors.

Evaluating the test object image can be carried out according to two main embodiments of the method. A first main embodiment is characterized in that the step of evaluating the test object image comprises the sub-steps of:

imaging the radiation source in a resist layer and developing the resist;

scanning the resist structure by means of a detection device having a higher resolution than the imaging system, and

analyzing data supplied by the detection device in order to determine the types and amounts of different aberrations, which may be present in the source image.

Higher resolution is understood to mean allowing the detection of smaller details.

A second main embodiment is characterized in that the step of evaluating the test object image comprises the sub-steps of:

forming an aerial image on a radiation sensitive detector;

scanning the aerial image, and

analyzing data supplied by the detector in order to determine the types and amounts of aberrations, which may be present in the source image.

This embodiment may be further characterized in that the step of forming an aerial image comprises simultaneously forming aerial images on separate detector areas.

This allows measuring local-effective-source variations across the field of the projection system.

The novel method is especially suitable for measuring the performance of an illumination system of a lithographic projection apparatus. The embodiment of the method for this application is characterized in that:

the step of providing a test object comprises providing a mask comprising at least one test object, and

the step of arranging the test object in the object plane comprises arranging this mask in a mask holder of the projection apparatus.

An embodiment of the method is characterized in that use is made of a test object, which forms part of a test mask.

A test mask, or reticle, may comprise a large number of Fresnel zone lenses and allows carrying out different types of measurements.

An alternative embodiment is characterized in that use is made of a test object, which forms part of a production mask.

This allows quick measuring, without inserting a special test mask in and removing it from the projection apparatus.

The invention also relates to a system for performing the method. This system is characterized in that it comprises the combination of:

an apparatus of which the illumination system forms part;

a test object having at least one Fresnel zone lens and an associated reference mark;

detection means for detecting the intensity profiles of the local effective source image formed by the Fresnel lens and of the image of the reference mark;

an image processor, coupled to the detection means, for storing and analyzing observed images, and comprising analysis means for processing information about observed images to determine different kinds of aberrations the illumination system may show.

A first embodiment of this system is characterized in that the detection means comprises a resist layer for receiving a source image formed by the at least one Fresnel lens and an image of the associated reference mark and a scanning detection device for scanning said images formed and developed in the resist layer.

Preferably the scanning detection device is a scanning electron microscope.

A second embodiment of this system is characterized in that the detection means comprises a radiation-sensitive detector for receiving a source aerial image formed by the Fresnel lens and an aerial image of the reference mark.

This embodiment may be further characterized in that the detector is a scanning point detector.

Another embodiment of the system is characterized in that the test object comprises a number of Fresnel zone lenses and associated reference marks, in that the detector is a scanning composed detector comprising a radiation-sensitive member and a number of transparent point-like areas, corresponding to the number of Fresnel zone lenses in the test object.

This embodiment may be further characterized in that the radiation sensitive member is a single element covering all transparent areas.

Alternatively, this embodiment may be characterized in that the radiation sensitive member is composed of a number of sub-members, which number corresponds to the number of transparent areas.

This embodiment may be further characterized in that the position of the transparent area relative to the center of the corresponding sub-members is different for the various transparent area/sub-member pairs.

The novel method is very suitable to be used in combination with a measuring device, which is characterized in that it has the shape and dimensions of a production substrate and comprises electronic signal processing means, power supply means, interface means and at least one detector for detecting intensity profiles of a source aerial image formed by a Fresnel lens and an aerial image of an associated reference mark.

This measuring device may be called a sensor wafer and can be transported through the lithographic projection apparatus in the same way as a normal wafer. The at least one detector of the sensor wafer may have the detector configurations as described above.

The invention also relates to a test object for use with the novel method. This test object is characterized in that it comprises at least one Fresnel zone lens and an associated reference mark.

A first embodiment of the test object is characterized in that it is implemented as a test mask.

A second embodiment of the test object is characterized in that it forms part of a production mask.

The test object may be further characterized in that it an amplitude structure.

Alternatively, the test object is characterized in that it has a phase structure.

The test object may be further characterized in that it is a transmission object.

Alternatively, the test object is characterized in that it is a reflective object.

The invention also relates to a process of manufacturing devices comprising device features in at least one substrate layer of device substrates, which process comprises at least one set of the following successive steps:

providing a production mask pattern comprising features corresponding to device features to be configured in said layer;

illuminating by means of a controlled illumination system the production mask pattern;

imaging, by means of a projection system, the production mask pattern in a resist layer coated on the substrate and developing this layer, thereby forming a patterned coating corresponding to the production mask pattern;

removing material from, or adding material to, areas of the substrate layer, which areas are delineated by the pattern of the patterned coating, said controlling of the illumination system comprising detection of aberrations of the illumination system and re-setting of this system based on the result of the detection. This process is characterized in that the detection is performed by means of the measuring method described hereinabove.

The invention further relates to a lithographic projection apparatus for imaging a production mask pattern, present in a mask, on a substrate, which apparatus comprises a controlled illumination system for supplying a projection beam, a mask holder for accommodating a mask, a substrate holder for accommodating a substrate and a projection system arranged between the mask holder and the substrate holder, said controlling of the illumination system comprising detection of aberrations of the illumination system and re-setting this system based on the result of the detection. This apparatus is characterized in that the detection is performed by means of the measuring method described hereinabove.

As by using the measuring method of the invention in the above-described lithographic process and apparatus better-defined devices can be obtained, the invention is also embodied in such devices.

These and other aspects of the invention are apparent from and will be elucidated, by way of non-limitative example, with reference to the embodiments described hereinafter.

In the drawings:

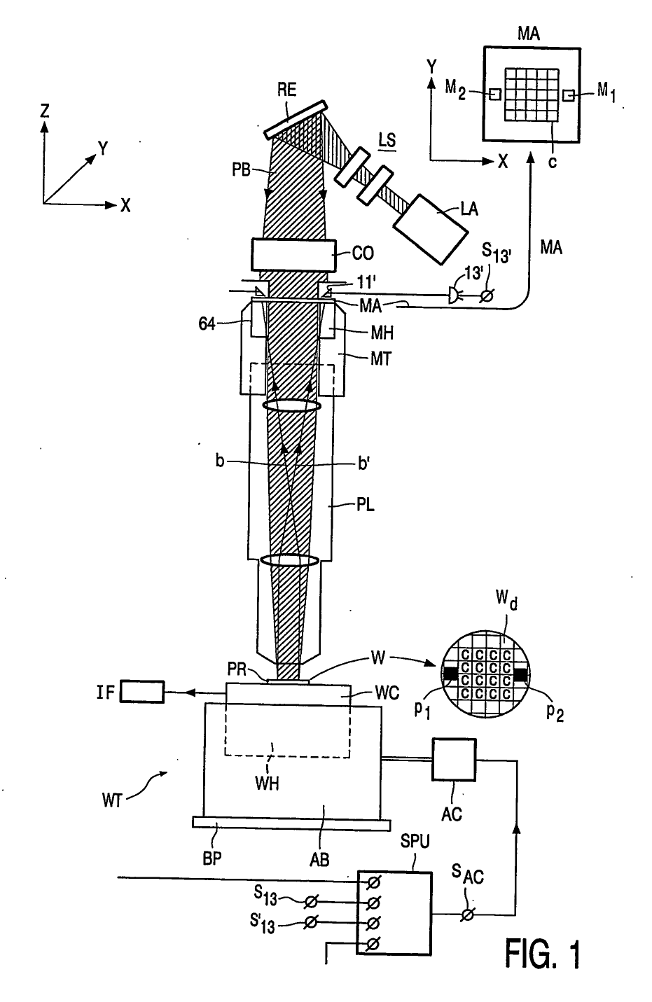

FIG. 1 shows diagrammatically an embodiment of a lithographic projection apparatus comprising an illumination system, the performance of which can be measured by means of the method;

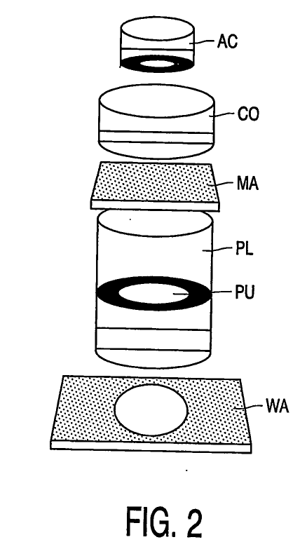

FIG. 2 shows a simplified embodiment of such an apparatus comprising only the elements which are needed for understanding the invention;

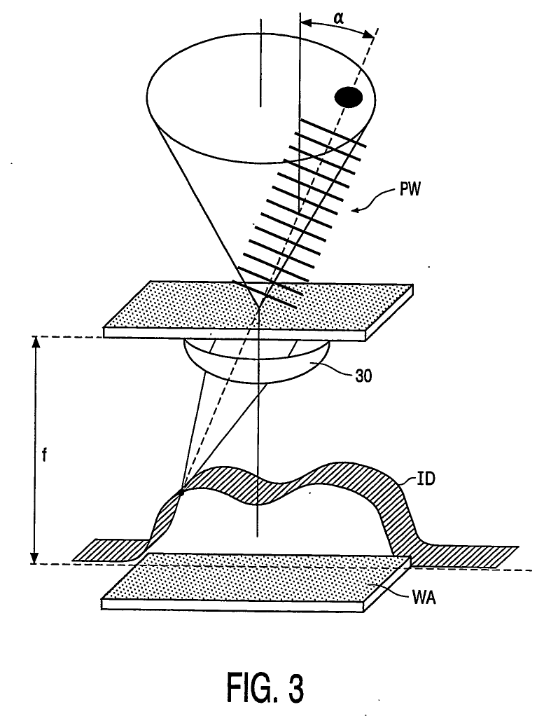

FIG. 3 shows the effect a Fresnel zone lens has on a plane wave from the illumination system of the apparatus;

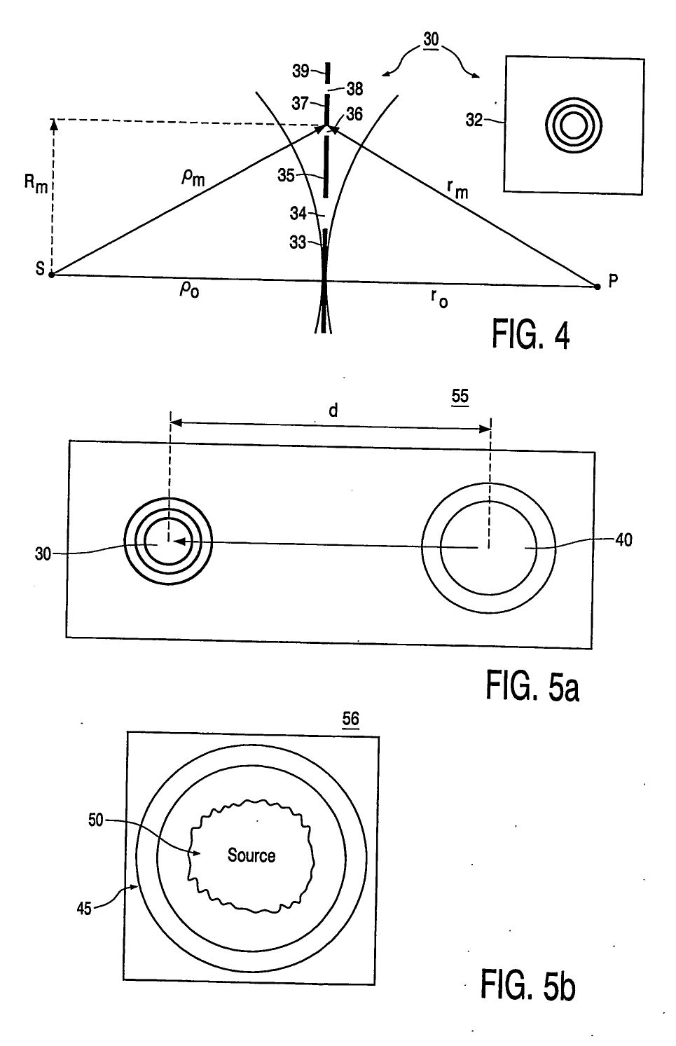

FIG. 4 shows the principle of a Fresnel zone lens;

FIG. 5a shows a portion of a test object comprising one Fresnel zone lens and the associated reference ring;

FIG. 5b shows the superposed images of this Fresnel zone lens and ring formed in a resist layer;

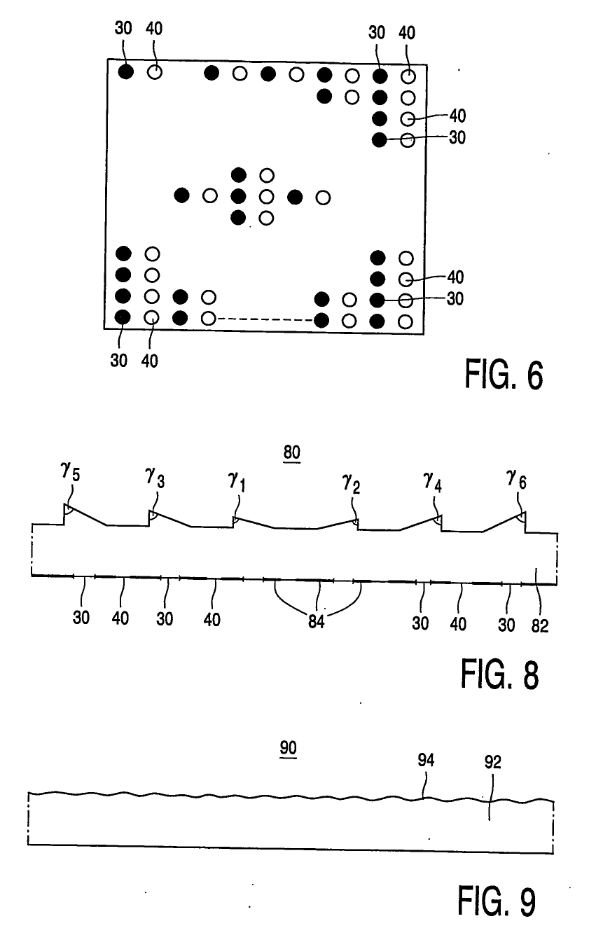

FIG. 6 shows a test object in the form of a test reticle comprising a number of Fresnel zone lenses and associated reference rings;

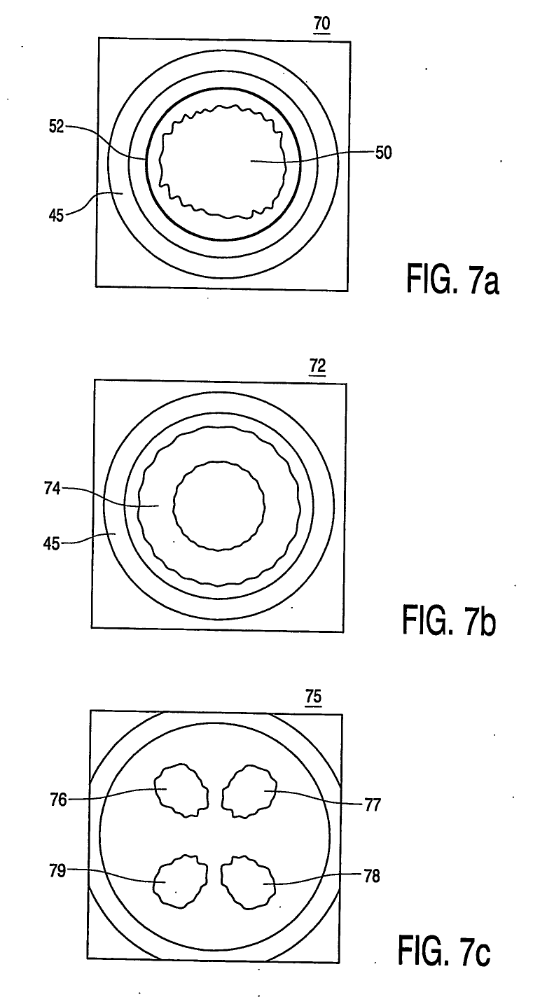

FIGS. 7a, 7b and 7c show images of different types of illumination sources;

FIG. 8 shows a test object provided with wedges;

FIG. 9 shows such a test object provided with a diffusing surface, and

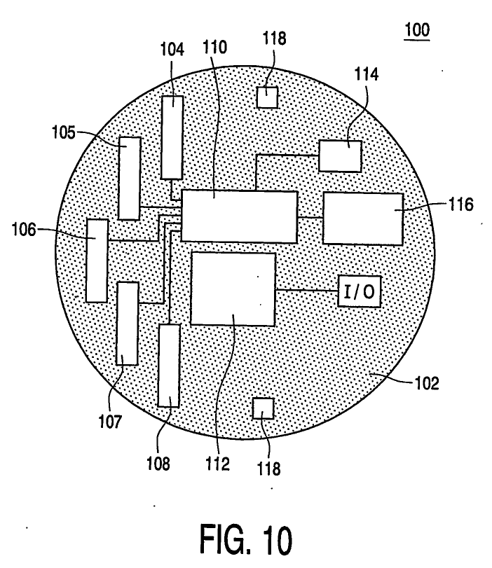

FIG. 10 shows a sensor wafer for use with the method.

In the schematic diagram of FIG. 1 only the most important modules of an embodiment of a lithographic projection, or exposure, apparatus are shown. This apparatus comprises a projection column wherein a projection system, for example, a lens projection system PL is accommodated. Above this system a mask holder MH for carrying a mask MA is arranged, which mask comprises a mask pattern C to be imaged. The mask pattern is a pattern of features corresponding to the features to be configured in a layer of a substrate, or wafer, W. The mask holder forms part of a mask table MT. A substrate table WT is arranged in the projection column beneath the projection lens system. The substrate table is provided with a substrate holder WH for holding a substrate, for example a semiconductor wafer, W. A radiation-sensitive layer PR, for example a photoresist layer, is coated on the substrate. The mask pattern C should be imaged a number of times in the resist layer, every time in another IC area, or die, Wd. The substrate table is movable in the X- and Y-direction such that, after the mask pattern has been imaged in an IC area, a next IC area can be positioned under the mask pattern and the projection system.

The apparatus further comprises an illumination system IS that comprises a radiation source LA, for example a mercury lamp or an excimer laser like a Krypton-Fluoride excimer laser, a lens system LS, a reflector RE and a collector lens CO. The illumination system may comprise a so-called integrator, i.e. an element that mixes the inner and outer portions of the beam from the source so that this beam gets a uniform intensity distribution. An illumination, or exposure, beam PB supplied by the illumination system illuminates the mask pattern C. The projection system PL images this pattern in an IC area on the substrate W.

The apparatus is further provided with a number of measuring systems. A first measuring system is an alignment measuring system for determining alignment, in the XY-plane, of the substrate with respect to the mask pattern C. A second measuring system is an interferometer system IF for measuring the X- and Y-position and the orientation of the substrate. Also present is a focus-error detection system (not shown) for determining a deviation between the focus, or image, field of the projection system and the radiation-sensitive layer PR on the substrate. These measuring systems are parts of servo systems, which comprise electronic signal processing- and control circuits and actuators by means of which the position and orientation of the substrate and the focus can be corrected at the hand of the signals delivered by the measuring systems.

The alignment detection system uses two alignment marks M₁ and M₂ in the mask MA, which marks are shown in the right top section of FIG. 1. These marks are, for example, diffraction gratings, but may also be constituted by other marks, like squares or strokes, which are optically different from their surroundings. Preferably the alignment marks are two-dimensional, i.e. they extend in two mutually perpendicular directions, the X- and Y-direction in FIG. 1. The substrate W comprises at least two alignment marks, two of which, P₁ and P₂ are shown in FIG. 1. These marks are positioned outside the area of the substrate W where the images of the mask pattern have to be formed. Preferably the grating marks P₁ and P₂ are phase gratings and the grating marks M₁ and M₂ are amplitude gratings. The alignment detection system may be a double system wherein two alignment beams b and b′ are used for detecting alignment of the substrate mark P₂ with respect to the mask mark M₂ and for detecting alignment of the substrate mark P₁ with respect to the mask mark M₁, respectively. After having traversed the alignment detection system, each of the alignment beams is incident on a radiation sensitive detector 3 and 3′, respectively. Each detector converts the relevant beam into an electrical signal that is indicative of the degree to which the substrate mark is aligned with respect to the mask mark, and thus the degree to which the substrate is aligned with respect to the mask. A double alignment detection system is described in U.S. Pat. No. 4,778,275, which is referred to for further details about this system.

For accurately determining the X- and Y-position of the substrate, the lithographic apparatus comprises a multiple-axis interferometer system, which is schematically indicated by the block IF in FIG. 1. A two-axis interferometer system is described in U.S. Pat. No. 4,251,160 and a three-axis interferometer system in U.S. Pat. No. 4,737,823. In EP-A 0,498,499 a five-axis interferometer system is described, by means of which both displacements along the X- and Y-axis and rotation about the Z-axis and tilts about the X- and Y-axis can be measured very accurately.

As indicated in FIG. 1, the output signal Si of the interferometer system and the signal S₃ and S₃′ of the alignment detection system are supplied to a signal processing circuit SPU, for example a micro computer, which processes these signals to control signals Sac for an actuator AC. This actuator moves the substrate holder WH in the XY-plane, via the substrate table WT.

The output signal of the above mentioned focus-error detection system is employed for correcting focus errors, for example, by moving the projection lens system and the substrate relative to each other in the Z-direction, or by moving one or more lens elements of the projection system in the Z-direction. A focus-error detection system, which may be fixed to the projection lens system, is described in U.S. Pat. No. 4,356,392. A detection system by means of which both a focus-error and a local tilt of the substrate can be detected is described in U.S. Pat. No. 5,191,200.

There is a steady demand to decrease the details, the width of a device feature, or line, and the distance between neighbouring device features, in order to increase the operating speed of the device and/or to increase the number of components in such a device. The smallness of the details which can be imaged in a satisfactory way by a lithographic projection apparatus, of which FIG. 1 shows an example, is determined by the imaging quality and resolving power of the projection system. Conventionally the resolving power, or resolution, has been improved by increasing the numerical aperture NA and/or decreasing the wavelength of the projection radiation. A further increase of the numerical aperture can hardly be expected in practice and a further reduction of the wavelength of the projection beam will pose a lot of new problems.

A more recent development on the way to imaging smaller pattern details with projection systems that can still be manufactured is the use of a step-and-scanning lithographic apparatus, instead of a stepping lithographic apparatus. In a stepping apparatus, a full-field illumination is used; i.e. the entire mask pattern is illuminated in one operation and imaged as a whole on an IC area of the substrate. After a first IC area has been exposed, a step is made to a next IC area, i.e. the substrate holder is moved in such a way that the next IC area is positioned under the mask pattern. Thereafter this IC area is exposed, and so forth until all IC areas of the substrate are provided with an image of the mask pattern. In a step-and-scanning apparatus only a rectangular or circular-segment-shaped area portion of the mask pattern is illuminated and hence also a corresponding sub-area of the substrate IC area is each time exposed. The mask pattern and the substrate are moved synchronously through the projection beam, while taking the magnification of the projection system into account. In a continuous process subsequent sub-areas of the mask pattern are then each time imaged on corresponding sub-areas of the relevant IC area. After imaging the entire mask pattern on an IC substrate area in this way, the substrate holder performs a stepping movement, i.e. the beginning of a next IC area is moved in the projection beam. The mask is then set, for example, in its initial position whereafter said next IC area is scan-exposed. As in the step-and-scanning method only the central part of the image field is used and thus only this part has to be corrected for optical aberrations, a relatively large numerical aperture can be employed. In this way the width of the device features and their interspaces, which can be imaged with the required quality, can be decreased to a certain degree.

To allow using the capability of a projection lens, i.e. the capability to image very accurately small details of a mask pattern in a resist layer, to the optimum, the illumination system should show a high performance quality and this system should be accurately aligned with respect to the optical axis of the projection lens. The smaller the details which can be imaged by the projection lens, the higher the requirements to be imposed on the illumination system.

FIG. 2 shows a diagram of a lithographic projection apparatus wherein a so-called Kohler illumination is used, which is the type of illumination mostly used in current wafer steppers and wafer step-and scanners. Kohler illumination means that the radiation source of the illumination system is imaged in the pupil plane of the projection lens. The pupil is denoted by Pu in FIG. 2. In this embodiment the radiation source supplies an annular beam, which is denoted by annular source AC. Illumination with an annular beam provides the advantage that the resolution of the projection system is enhanced, i.e. smaller details can be imaged.

As illustrated in FIG. 3, an illumination beam is supplied, which is composed of a distribution of plane waves PW. The distribution at the level of the mask pattern, or reticle, is called: local effective source. This distribution is determined by the characteristics of the illumination system. Aberrations of this system cause variations in this distribution. Thus, illumination system aberrations result in a variation of the shape of the source across the field of the projection apparatus. As the width of a printed line, i.e. a line in the resist layer formed by the projection lens, depends on the shape of the effective source at the location of the relevant line in the mask pattern or reticle, condenser aberrations contribute to variations of the printed line width across the field of the projection lens. To eliminate, or reduce to an acceptable level, this type of line width variations, illumination system aberrations should be determined and measures should be taken to reduce or eliminate these aberrations. The aberrations include: tilt of the illumination system with respect to the imaging system, telecentricity error, which is constant across the image field, and focus error, which causes off-axis image defects.

Illumination system aberrations could be measured by determining the radiation distribution in the pupil plane of the projection lens. However, usually this plane is not accessible. A known solution to this problem is to re-image the effective source by means of additional lens means arranged in the plane of the reticle. The simplest lens means for re-imaging would be a transparent hole in an opaque reticle. The optimum diameter R for the hole is given by the condition that the size of the radiation spot formed by means of the hole equals the size of a diffraction-limited spot:
R≈(λF)^{1/2} (1)

Wherein λ is the wavelength of the source radiation and F is the distance between the hole and the plane where the spot is formed.

Improved lens performance, thus an improved image of the radiation source, is obtained if a Fresnel zone lens replaces the single hole. The amplitude version of a Fresnel zone plate comprises a central circular area and a number of annular zones, which are alternately transparent and non-transparent. In FIG. 3 such a Fresnel lens is symbolised by a curved lens element 30, which converges the radiation associated with one of the plane waves PW on the wafer WA. The curve ID above the wafer represents the intensity distribution of the image formed by the combination of the Fresnel zone lens and the projection lens. For clarity sake the latter has been omitted from FIG. 3.

FIG. 4 shows very schematically a zone lens 30, which is formed by a plate 32 comprising a central circular zone 32 and a number of alternating transparent and non-transparent annular zones, of which only six zones 34-39 are shown. The radii Rm. of the zones are chosen such that a plane wave that travels from (object) point S to (image) point P via zone number m shows a phase difference of m.λ/2 with the wave that propagates along the optical axis. As the transparent zones all have an odd number or an even number, waves passing through the transparent zones all interfere constructively in point P. The radius of the zones are given by:
R²ₘ=m.λ.f+(m²λ²)/4≈m.λ.f (2)

For image forming by means of a Fresnel lens the “thin lens equation” holds:
1/ρ₀+1/r₀=1/f, with f=R²ₘ/(m.λ) (3)

A plane wave thus focuses in a plane at a distance f, i.e. the focal length of the Fresnel zone lens, from this lens.

In practise, the focal length f is chosen to be within the range of defocus values of the projection lens for which the focus system of the projection apparatus can compensate. A typical range extends from −30 μm to +30 μm from nominal focus. The focal length of the Fresnel zone lens may then be 15 μm. The number of zones of the Fresnel lens, in a practical embodiment for example five, is a compromise between the resolution of this lens and the off-axis aberrations that a Fresnel lens having a relative large number of zones and a correspondingly relatively large NA may show.

To determine aberrations of the illumination system the radiation source is imaged by means of the Fresnel zone lens and the projection lens in a resist layer on top of a substrate. A parameter that is currently used in projection lithography is the coherence value σ, which is a measure of the degree to which the illumination beam fills the pupil of the projection lens. If the beam fills the entire pupil, σ=1, but usually σ<1. The angle α at which a plane wave PW is incident on the Fresnel zone lens 30 (FIG. 3) can be represented by:
Sin α=σ.NA.M (4)
wherein M is the magnification of the imaging system. This plane wave is focused at a distance r from the optical axis:
r=(f.σ.NA)/(1−σ².NA²)^{1/2} (5)

For a projection apparatus having a projection lens with a numerical aperture NA=0.63 and a coherence value σ=1, the image of the radiation source would have a diameter of 24 μm at wafer level. It is to be noted that the angle of incidence α associated with these values for σ and NA is fairly large and that in practice a smaller angle of incidence will be chosen to avoid introduction of aberrations by the Fresnel zone lens. This means that the diameter of the radiation source image will be smaller than said 24 μm.

According to the invention, in addition to a local effective source also a reference mark, which is present in the test reticle, or test object, and is associated with the Fresnel zone lens, is imaged. The local effective source and the reference mark are imaged close to each other, i.e. in the image field of the detection device so that the can be viewed by this device as one composed image. Imaging a reference mark belonging to a Fresnel zone lens, which mark has a well defined position with respect to the Fresnel zone lens, at a well-defined position in the image plane allows determining the position of the image of the Fresnel in an easy way. The centre of the reference mark image can be used as the origin of a two-dimensional co-ordinate system and the shape and dimension of the effective source image can be determined by means of the origin and the axes of this co-ordinate system.

The Fresnel zone lens and the reference mark may be imaged next to each other. Preferably, the Fresnel zone lens area and the corresponding reference mark area are imaged as being superposed. This allows more accurate and faster measuring because the position of the image of the local effective source need not be “translated” to the position of the reference mark. Superposed imaging of the local effective source and the reference mark allows measuring telecentricity errors.

The reference mark may be formed by small lines which are arranged at angles of 90° with respect to each other and which may be distinct lines or lines together forming a square. The reference mark may have any form, provided that it has a clearly discernible centre.

However, the reference mark is preferably an annular mark.

This allows comparing the shape of the image of the local effective source, which should be circular, with the circular contour lines of the image of the annular reference mark (hereinafter: reference ring). In this way different types of aberrations of the illuminating system can be determined.

FIG. 5a shows a portion of the test reticle comprising a Fresnel zone lens 30 and the associated test ring 40. The radius R of the first zone of the Fresnel zone lens is for example of the order of 2 μm in case λ=248 nm and f=15 μm. The diameter of the test ring, which diameter is larger than the diameter of the Fresnel zone area, is determined by the maximum σ- and NA values of the apparatus whose illumination system is to be measured. The distance d between the centre of the test ring and the centre of the Fresnel zone lens is, for example, 100 μm.

The test object shown in FIG. 5a may be constituted by a transparent plate, for example, of glass or quartz, whose lower side is coated with a non-transparent layer of, for example, chromium. The Fresnel lens and the reference ring consist of transparent areas and zones in the non-transparent layer. Instead of such a transparent/non-transparent, i.e. amplitude, structure also a phase structure may be used as a test object. The whole test object then is transparent and the Fresnel zone lens and the reference ring consist of area-and zone-recesses in the plate. Preferably the depth of the recesses is λ/4 if the surrounding medium is air having a refractive index of 1. Instead of recesses, also raised areas and zones may be used having the same area and zone sizes and the same height difference with respect to the rest of the plate as said recesses.

Instead of a transmission object, the test object may also be a reflective object. A reflective test object will be used for measuring an illumination system which supplies radiation having such a short wavelength that materials, which are sufficiently transparent to this wavelength are not available. The illumination system and the projection system then comprise mirrors instead of lenses. A reflective test object will be used for measuring an illumination system which supplies, for example, extreme UV (EUV) radiation having a wavelength of, for example, 13 nm.

For performing a measurement, first the resist layer is defocused with respect to the projection lens over a distance equal to the focal length of the Fresnel zone lens, for example 15 μm, by moving the wafer stage from its nominal position over this distance along the optical axis. An image of the radiation source is formed via the Fresnel zone lens in the resist layer. As the extent to which the resist layer is defocused is equal to the focal length of the Fresnel zone lens, this image is a sharp image. Then the wafer stage is set to its nominal Z position and moved in the X direction over a distance d. The latter movement is carried out by the accurate X stage actuator or motor and the X interferometer system, which means that this movement can be realised with nanometer precision. The centre of the reference ring is now at the former position of the centre of the Fresnel zone lens. Illumination of the test ring results in a second image in the resist.

FIG. 5b shows the image 45 of the reference ring and the image 50 of the local effective source formed via the Fresnel zone lens. The diameter of the source image is, for example, of the order of 15 μm and that of the ring image of the order of 30 μm. The composed image can be evaluated by means of a scanning electron microscope (SEM), which is provided with image processing and evaluating electronic hardware and software. Such a SEM is widely used in optical lithography for evaluating test images formed of production reticle patterns or parts thereof. For performing the illumination system measuring method an adapted and dedicated software package is used.

Imaging a reference ring superimposed on the image of the radiation source provides the advantages of having a mark for the position of the source image and having a reference for determining shift and deformations of the source image.

As the reference ring is imaged in focus, for this imaging a nominal illumination dose (intensity of the projection beam PB) can be used. Because the source is imaged out of focus via the Fresnel zone lens, preferably the illumination dose for this imaging is considerably, for example 20 times, larger than the nominal illumination dose. This is a safety margin to have sufficient radiation incident on the required position in the resist layer.

Instead of by imaging in a resist layer, the method can also be performed by using an aerial image of the reference ring and an aerial image of the radiation source formed by the Fresnel zone lens. The possible influence of resist characteristics on the measurement is then excluded. The aerial images are projected on a radiation-sensitive detector, which converts the images into electrical signals. The detector signals are supplied to an image processing and evaluating device coupled to the detector. An example of such a detector is an image sensor, which is widely used in lithographic projection apparatus for evaluating the performance of the projection column of such an apparatus. The aerial images of the source and the reference ring are scanned by the detector at different time intervals and their data are processed such that a composed image similar to that shown in FIG. 5b is obtained.

In a previous WO patent application No. 02/01485 (PHNL010996), which relates to a method of measuring projection lens aberrations by means of measuring test feature images, several embodiments of detectors are described, which detectors can also be used with the method of the present invention.

A first type of detector that can be used with the method for measuring an illumination system is a scanning point detector.

In case the test object comprises a number of Fresnel zone lenses and associated reference rings the detector may be a scanning composed detector comprising a radiation-sensitive member and a number of transparent point-like areas, corresponding to the number of Fresnel zone lenses in the test object.

The radiation-sensitive member may be a single element covering all transparent areas.

Alternatively the radiation sensitive member is composed of a number of sub-members, which number corresponds to the number of transparent areas.

In an embodiment wherein al aerial images of the local effective source are formed simultaneously, these images can be taken in simultaneously if use is made of a detector wherein the position of a transparent area relative to the center of the corresponding sub-member is different for the various transparent area/sub-member pairs.

By evaluation of the composed image of FIG. 5b the new method allows determining of different types of possible illumination aberrations. If the reference ring image 45 and the image 50 of the source are coaxial the illumination system and the projection lens are well aligned. If the centre of image 50 is shifted with respect to the centre of the image 45 so-called telecentric errors occur. This means that the illumination system is tilted with respect to this optical axis. A telecentric error causes a focus dependent image distortion in the form of a shift of especially the larger pattern features that is focus dependent and can affect the alignment or overlay accuracy during the production process. As a rule of thumb: a larger (coarse) feature will shift approximately Δσ.NA.ΔZ, wherein Δ Z is the focus shift. For example, a telecentric error of 1% causes a line width variation of a coarse feature in case NA=0.6 and ΔZ=0.4 μm. A coarse feature is, for example, an alignment mark. The shift for fine features, i.e. features having a width near the resolution of the projection lens, is very small to zero.

A second type of aberration that can be measured by means of the method is variation of the size of the local effective source across the field of the projection lens. Such a variation means a variation Δσ of the coherence value and causes a variation of the imaged feature- or line-width across the field of the projection lens. For example, for Δσ˜1% the line width variation ΔCD for the critical dimension CD, which may be the smallest dimension of the pattern, may be ΔCD˜1 nm. The line width variation is strongly dependent on the pitch, or periodicity, of the mask pattern and on the type of illumination, for example circular, annular, dipole or quadrupole illumination. Moreover the line width variation for an isolated feature and for a dense feature have opposite sign. An isolated feature is a mask pattern feature that has no neighbour feature at a distance in the order of a few times the line width. A dense feature forms part of a pattern wherein the distance between neighbouring features is a few times the line width, for example a line having a width of 130 in a pattern having a pitch of 310 nm.

The method also allows determining deviations in the radiation distribution of the local effective source. Such deviations include: for a conventional (circular) source or an annular source an elliptical instead of a round shape, for a dipole or a quadrupole source imbalance between the poles and for both an annular source and a multi-pole source eccentricity of the annulus of the poles with respect to the geometrical centre. This type of deviations causes a deformation of an IC pattern image and a difference in line width for H lines (horizontal lines extending in the X-direction) and V lines (vertical lines, extending in the Y-direction). Deformation of the contour of the source image in FIG. 5b indicates a defect in the illumination system itself, i.e. a defect in or a position or tilt error of one or more of the elements of this system

For measuring across-the-field variations caused by the illumination system a number of composed images as shown in FIG. 5b should be formed, either in a resist layer or on an image sensor, every time at a different position in the image field of the projection lens. Preferably the plurality of composed images is obtained by means of a reticle that comprises a corresponding number of Fresnel zone lenses and associated reference rings. FIG. 6 shows an embodiment of such a reticle. In this FIG., the Fresnel zone lenses 30 are denoted by closed (dark) circlets and the reference rings by open circlets. By illuminating the whole pattern of Fresnel zone lens and reference ring pairs, the required composed images are obtained in one step, which means that the time needed for the measurement can be reduced. For this simultaneous imaging for all Fresnel zone lenses the same, preferably high, illumination dose is used and for all reference rings the same nominal illumination dose is used.

It is also possible to image the same Fresnel zone lens and associated reference ring a number of times, each time at a different position in the resist layer. Then the test object should be stepped between the successive illuminations, which may require additional means. In a step-and-scanning lithographic apparatus the reticle can be stepped in one direction. This embodiment of the method allows illuminating the Fresnel zone lens each time with a different dose, whilst for the successive illuminations of the reference ring the same dose is used. This allows enhancing the measuring capabilities of the method. By comparing the intensity profiles belonging to the different doses, via comparing the composed images formed in the resist layer, the performance of the illumination system over the whole illumination dose range can be determined.

As already remarked the method can be used to measure different types of illumination systems, like a conventional, an annular, a dipole or a quadrupole system.

FIG. 7a shows an example of the composed image 70 obtained by measuring a conventional illumination system, i.e. a system that supplies an illumination beam having a circular cross-section. As in FIG. 5a, the image of the source formed by means of the Fresnel zone lens is denoted by reference number 50 and the image of the reference ring is denoted by reference number 45. Circle 52 represents the best fitting contour of the image source.

FIG. 7b shows an example of the composed image 72 obtained by measuring an annular illumination system, i.e. a system that supplies an illumination beam having an annular cross-section. The source image formed by means of the Fresnel zone lens, which is denoted by reference number 74, has an annular shape.

FIG. 7c shows an example of the composed image 75 obtained by measuring a quadrupole illumination system, i.e. a system that supplies an illumination beam that is composed of four sub-beams, which are arranged in different quadrants around the geometrical centre. This centre should be situated at the optical axis of the projection lens. The four illumination areas formed by the sub-beams and the Fresnel zone lens are denoted by reference numbers 76, 77, 78 and 79.

The data relating to tilt and defocus of the illumination system obtained by means of the method can be used to correct the illumination system in order to remove or reduce to an acceptable level the measured aberrations. The type of correction to be made depends on the kind of aberration and may include shifting or tilting the system with respect to the optical axis of the projection lens, shifting or tilting of the radiation source of the imaging system and shifting or tilting of optical components of this system with respect to each other or the radiation source.

At a manufacturing site where several lithographic projection apparatuses are installed, the illumination systems of these apparatuses may all be measured by means of the same test reticle, which comprises one or more Fresnel zone lenses and associated reference rings, and corrected. In this way the illumination systems of the projection apparatuses can be matched to each other.

As the Fresnel zone lens and the reference ring occupy only small areas of a reticle, one or more Fresnel lenses and associated reference rings (hereinafter measuring elements) can also be arranged in a production reticle or mask, i.e. a mask having a mask pattern with features corresponding to the features to be configured in a layer of the substrate during the manufacture of a device. This allows carrying out the method without using a special test reticle and, for example, at the start of an exposure process for a batch of wafers. The measuring elements may be arranged at the border of a production reticle where no features of the mask pattern are present.

As for imaging the local effective source and the reference ring the projection lens is used, aberrations of this lens may cause distortions in the images of the measuring elements. For a reliable measurement of the imaging system the projection lens aberrations should be measured and this lens should accordingly be corrected before measuring the imaging system so that only aberrations of the latter system are measured. An accurate and reliable method for measuring projection lens aberrations is described in U.S. Pat. No. 6,248,486. In an article entitled: “Measurement of effective source shift using a grating-pinhole mask”, published in SPIE Vol. 3679, 1999, pages 99-107 a method is described to measure shift of the effective source directly, without first measuring aberrations of the projection lens. This method uses a mask comprising a number of transparent areas wherein gratings are arranged. These areas have a double function: they act as a pinhole lens and as a diffraction grating, which splits an incident beam in a number of sub-beams of different diffraction orders. In the measuring system of the article a zero order sub-beam passes thorough the centre of the projection lens pupil and four first order beams pass through different areas at the border of the pupil. Each of the sub-beams has a low intensity and the results of the measurement are strongly dependent on the pitch of the grating.

According to a further aspect of the invention the new method described thus far can also be adapted such that the measurements are not influenced by transmission defects of the projection lens, and this adaptation can be realized without using critical measuring elements and without loss of radiation energy. To that end a test reticle is used which comprises a wedge for each of the Fresnel zone lenses. The wedges have different wedge angles so that all sub-beams passing through them and the associated Fresnel zone lens are deflected at a different angle. By illuminating this test reticle, each of the sub-beams forming an effective source image passes through another area of the projection lens pupil than the other sub-beams. The collection of these images thus comprises information about transmission defects of the projection lens, which allows correcting the illumination system measurement results for these defects and/or making visible these defects.

FIG. 8 shows a cross-section of an embodiment of a reticle comprising wedges. The reticle 80 comprises a substrate 82 and a number of Fresnel zone lenses 30 and associated reference rings 40. The surface areas 84 between the zone lenses and the rings are non-transparent and may be formed by a chromium layer. This structure may also be used for a reticle having no wedges. FIG. 8 shows a central portion of the reticle so that the inclination of wedges 90, 94, 98 at the left side is opposed to the inclination of wedges 92, 96, 100 at the right side. In this embodiment the wedge angle γ of the wedges increases in the direction from the centre to the border. Each wedge belongs to a different one of the Fresnel zone lenses so that radiation passing through a Fresnel zone lens has a direction, which is determined by the wedge angle of the associated wedge. For clarnity the difference shown in FIG. 8 between the wedge angles γ₁, γ₃ and γ₅ and the wedge angles γ₂, γ₄ and γ_{6 is} is larger than it is in practice. The distance between the wedges and thus between the lenses is also shown larger than it is in reality.

Alternatively the method can be enlarged with the additional step of measuring transmission defects of the projection lens before measuring the illumination system. The transmission defects can be measured by illuminating the projection lens with a beam having a uniform radiation distribution. Then the radiation distribution in the image plane will be uniform too, provided the projection lens shows no transmission defects. If such defects are present, the radiation intensity at areas in the image plane corresponding to the location of the defects will be smaller than in the rest of the image plane. To obtain diffuse radiation, a separate diffusing element can be arranged above the reticle or the upper surface of a reticle can be made diffusive, for example by roughening it. FIG. 9 shows a test reticle 90 comprising a transparent substrate 92 and a roughened upper surface 94 that can be used for measuring the projection lens.

When used for measuring the performance of an illumination system of a lithographic projection apparatus, the novel method can be carried out by means of a special optical measuring device. FIG. 10 shows an embodiment of such a device 100. It comprises a substrate 102, which has the shape and the dimensions of a production wafer to be processed in the apparatus of which the illumination system to be measured forms part. The device, which may be called optical measuring wafer or sensor wafer, comprises at least one detector, or sensor. The embodiment of FIG. 10 comprises five sensors 104-108. At least one of the sensors may be a single or composed detector and be used for measuring the illumination system. The sensors may be distributed over the whole wafer surface and may be arranged at different heights. The sensors may be provided with an amplifier to amplify the sensor signal before it is supplied to a microprocessor 110, also arranged on the wafer. The functions of the microprocessor are a/o processing the sensor signals and controlling the sensors. The sensor wafer may also comprise a memory 112 for temporarily storing data, such as signal data. Block 114 is an input/output interface, which is connected to the microprocessor and provides for a wireless or wired contact with the environment. The wireless contact may be provided, for example, by optical means or by FM transmission. The interface is used for supplying data to the environment and/or loading a measurement program into the microprocessor. The sensor wafer is powered by a power supply 116, which may be a battery or an induction device for wireless reception of electric power from the environment. The sensor wafer comprises also two or more alignment marks to align the wafer in the lithographic projection apparatus before measuring is started. The advantage of the sensor wafer is that it can be placed in and removed from the apparatus as a normal wafer.

Although the invention has been described at the hand of a lithographic projection apparatus having a projection lens system, the invention can also be used in an apparatus wherein the projection system, i.e. a system for imaging a production mask pattern in a resist layer on top of a substrate, is a mirror system or a system comprising mirrors and lenses.

The method of the invention can be used by a manufacturer of an illumination system to measure and correct a manufactured illumination system before delivering it. It can also be used by the manufacture of lithographic projection apparatuses to measure the illumination and to align it with the projection system. This results in an improved projection apparatus so that the invention is embodied in such apparatus. Furthermore the invention can be used by a manufacturer of devices, such as ICs, or light valve devices, like liquid crystal display panels and digital mirror devices (DMD), or integrated and planar optical systems etc, to regularly measure the illumination system of the projection apparatus. Such use allows more accurate manufacturing of such devices and thus results in better defined devices. The invention is thus also embodied in such devices.

The fact that the invention has been described at the hand of measuring an illumination system for a projection apparatus does not mean that its application is limited to this application. The invention may be used wherever the aberrations of an illumination system must be measured independently of each other and with great accuracy and reliability. When using the novel method in a lithographic projection apparatus, however, optimum use is made of the fact that this apparatus is intended for fine imaging patterns and that the imaging and servo systems of this apparatus may also be used for carrying out the novel method.

1. A method of measuring the performance of an illumination system, which comprises a radiation source and is used in an imaging apparatus, which method comprises the steps of:
providing a test object comprising at least one Fresnel zone lens;
arranging the test object in the object plane of the imaging apparatus;
imaging a test object area comprising a Fresnel zone lens in an image plane by means of an illumination beam supplied by the illuminating system and by means of the imaging system of the apparatus, whereby a local effective source is imaged in the image plane;
evaluating the image of the local effective source by means of a detection device and associated processing means to determine the performance of the illumination system, characterized in that the step of providing a test object comprises providing a test object having for each Fresnel zone lens a reference mark and in that the step of imaging comprises imaging of a Fresnel zone lens area and the corresponding reference mark area within the field of view of the detection device.

2. A method as claimed in claim 1, characterized in that the Fresnel zone lens area and the corresponding reference mark area are imaged as being superposed.

3. A method as claimed in claim 1, characterized in that the reference mark is an annular mark.

4. A method as claimed in claim 1, characterized in that the test object is imaged out of focus over a distance equal to the focal length of the Fresnel zone lens and in that the reference mask is imaged at best focus condition.

5. A method as claimed in claim 1, characterized in that for imaging the Fresnel zone lens an illumination dose is used that is substantially higher than the illumination dose used for imaging the reference mark.

6. A method as claimed in claim 1, using a test object having a number of Fresnel zone lenses and associated reference masks, characterized in that measures are taken to direct radiation from each Fresnel zone lense at a different angle through the pupil of the imaging system.

7. A method as claimed in claim 1, characterized in that before the illumination system is measured the imaging system is illuminated by diffuse radiation and the radiation distribution in its image plane is measured to detect transmission errors of the illumination system and in that the results of the illumination system measurement are corrected for the said transmission errors.

8. A method as claimed in claim 1, characterized in that the step of evaluating the test object image comprises the sub-steps of:
imaging the radiation source in a resist layer and developing the resist;
scanning the resist structure by means of a detection device having a higher resolution larger than the imaging system, and
analyzing data supplied by the detection device in order to determine the types and amounts of different aberrations, which may be present in the source image.

9. A method as claimed in claim 1, characterized in that the step of evaluating the test object image comprises the sub-steps of:
forming an aerial image on a radiation-sensitive detector;
scanning the aerial image, and
analyzing data supplied by the image sensor in order to determine the types and amount of aberrations, which may be present in the source image.

10. A method as claimed in claim 9, characterized in that the step of forming an aerial image comprises simultaneously forming aerial images on separate detector areas.

11. A method as claimed in claim 1, for measuring the performance of an illumination system in a lithographic projection apparatus, characterized in that:
the step of providing a test object comprises providing a mask comprising at least one test object, and
the step of arranging the test object in the object plane comprises arranging this mask in a mask holder of the projection apparatus.

12. A method as claimed in claim 11, characterized in that use is made of a test object, which forms part of a test mask.

13. A method as claimed in claim 11, characterized in that use is made of a test object, which forms part of a production mask.

14. A system for performing the method as claimed in claim 1, characterized in that it comprises the combination of:
an apparatus of which the illumination system forms part;
a test object having at least one Fresnel zone lens and an associated reference mark;
detection means for detecting the intensity profiles of a local effective source image formed by the Fresnel lens and of the image of the reference ring;
an image processor, coupled to the detection means, for storing and analyzing observed images and comprising analysis means for processing information about observed images to determine different kinds of aberrations the illumination system may show.

15. A system as claimed in claim 14, characterized in that the detection means comprises a resist layer for receiving a local effective source image formed by the at least one Fresnel lens and an image of the associated reference mark and a scanning detection device for scanning said images formed and developed in the resist layer.

16. A system as claimed in claim 15, characterized in that the scanning detetction device is a scanning electron microscope.

17. A system as claimed in claim 14, characterized in that the detection means comprises a radiation-sensitive detector for receiving a source aerial image formed by the Fresnel zone lens and an aerial image of the reference mark.

18. A system as claimed in claim 17, characterized in that the detector is a scanning point detector.

19. A system as claimed in claim 17, characterized in that the test object comprises a number of Fresnel zone lenses and associated reference marks, in that the detector is a scanning composed detector comprising a radiation-sensitive member and a number of transparent point-like areas, corresponding to the number of Fresnel zone lenses in the test object.

20. A system as claimed in claim 19, characterized in that the radiation sensitive member is a single element covering all transparent areas.

21. A system as claimed in claim 19, characterized in that the radiation sensitive member is composed of a number of sub-members, which number corresponds to the number of transparent areas.

22. A system as claimed in claim 21, characterized in that the position of the transparent area relative to the center of the corresponding sub-members is different for the various transparent area/sub-member pairs.

22. A system as claimed in claim 21, characterized in that the position of the transparent area relative to the center of the corresponding sub-members is different for the various transparent area/sub-member pairs.

23. A measuring device for use with the method as claimed in claim 1, characterized in that it has the shape and dimensions of a production substrate and comprises electronic signal processing means, power supply means, interface means and at least one detector for detecting intensity profiles of a source aerial image formed by a Fresnel lens and an aerial image of an associated reference mark.

24. A measuring device as claimed in claim 23, characterized in that the detector is a scanning point detector.

25. A measuring device as claimed in claim 23, characterized in that the detector is a composed detector comprising a radiation-sensitive member and a number of transparent point-like areas.

26. A measuring device as claimed in claim 25, characterized in that the radiation-sensitive member is a single element covering all transparent areas.

27. A measuring device as claimed in claim 25, characterized in that the radiation sensitive member is composed of a number of sub-members corresponding to the number of transparent areas.

28. A measuring device as claimed in claim 25, characterized in that the position of a transparent area relative to the center of the corresponding sub-member is different for the various transparent area/sub-member pairs.

29. A test object for use with the method as claimed in claim 1, characterized in that it comprises at least one Fresnel zone lens and an associated reference mark.

30. A test bject as claimed in claim 29, characterized in that the reference mark is an annular mark.

31. A test object as claimed in claim 29, characterized in that it is implemented as a test mask.

32. A test object as claimed in claim 29, characterized in that it forms part of a production mask.

33. A test object as claimed in claim 29, characterized in that it has an amplitude structure.

34. A test object as claimed in claim 29, characterized in that it has a phase structure.

35. A test object as claimed in claim 29, characterized in that it is a transmission object.

36. A test object claimed in claim 29, characterized in that it is a reflective object.

37. A process of manufacturing devices comprising device features in at least one substrate layer of device substrates, which process comprises at least one set of the following successive steps:
providing a production mask pattern comprising features corresponding to device features to be configured in said layer;
illuminating by means of a controlled illumination system the production mask pattern;
imaging, by means of a projection system, the production mask pattern in a resist layer coated on the substrate and developing this layer, thereby forming a patterned coating corresponding to the production mask pattern;
removing material from, or adding material to, areas of the substrate layer, which areas are delineated by the pattern of the patterned coating, said controlling of the illumination system comprising detection of aberrations of the illumination system and re-setting this system based on the result of the detection, characterized in that the detection is performed by the method as claimed in claim 1.

38. A lithographic projection apparatus for imaging a production mask pattern, present in a mask, on a substrate, which apparatus comprises a controlled illumination system for supplying a projection beam, a mask holder for accommodating a mask, a substrate holder for accommodating a substrate and a projection system arranged between the mask holder and the substrate holder, said controlling of the illumination system comprising detection of aberrations of the illumination system and re-setting this system based on the result of the detection, characterized in that the detection is performed by the method as claimed in claim 1.

39. A device manufactured by the process as claimed in claim 37.

40. A device manufactured by the apparatus as claimed in claim 38.
